(19) United States
(12) Patent Application Publication
(10) Pub. No.: US 2022/0204415 A1
(43) Pub. Date: Jun. 30, 2022

(54) PART MADE OF SILICON-BASED CERAMIC OR CMC AND METHOD FOR PRODUCING SUCH A PART

(71) Applicant: SAFRAN, Paris (FR)

(72) Inventors: Amar SABOUNDJI, MOISSY-CRAMAYEL (FR); Hugues Denis JOUBERT, MOISSY-CRAMAYEL (FR); Philippe PICOT, MOISSY-CRAMAYEL (FR); Luc Patrice BIANCHI, MOISSY-CRAMAYEL (FR)

(73) Assignee: SAFRAN, Paris (FR)

(21) Appl. No.: 17/608,246

(22) PCT Filed: Apr. 30, 2020
(86) PCT No.: PCT/FR2020/050734

§ 371 Date: Nov. 2, 2021

(30) Foreign Application Priority Data
May 3, 2019 (FR) FR1904633

(51) Int. Cl. C04B 41/52; C04B 41/50; C04B 41/45; C04B 41/87; C04B 35/565; C04B 35/80

(52) U.S. Cl. CPC C04B 41/522; C04B 41/5035; C04B 41/5024; C04B 41/4558; F01D 5/282; C04B 35/565; C04B 35/80; C04B 2235/3826; C04B 41/87

(57) ABSTRACT

The invention relates to a part made of silicon-based ceramic material or silicon-based ceramic matrix composite (CMC) material comprising an environmental barrier coating (EBC), said coating (12, 13) comprising a bonding layer (12) deposited on the surface of the ceramic material or ceramic matrix composite (CMC), said bonding layer (12) being topped by one or more layers together forming a multifunctional barrier structure (13), characterised in that the bonding layer (12) has at its interface with the multifunctional structure a polycrystalline silica layer (12) or sub-layer (12b).

### TECHNICAL FIELD AND PRIOR ART

The present invention relates to parts made of silicon-based ceramic material or silicon-based ceramic matrix composite (CMC) material.

The CMC materials are currently commonly considered in the aeronautic or space field, especially for the turbomachine parts that are subjected to high operating temperatures.

The economic and environmental constraints have prompted the engine manufacturers in the aeronautic industry to develop lines of research in view of reducing noise pollution, fuel consumption and NOx and CO₂ emissions.

To meet these requirements and especially the last two, one solution consists of increasing the temperature of the gases in the turbojet combustion chamber. This leads to an improvement of engine performance (reduction of kerosene consumption) and allows operating with a lean fuel mixture (NOx reduction). However, the materials used in the combustion chamber must be able to withstand higher temperatures.

Currently, the materials used in aeronautic engines for the parts subjected to high operating temperatures are superalloys. However, the temperatures reached (around 1100° C.) are close to their limit of use.

In order to significantly increase these use temperatures (up to 1400° C.), for several years, the use of silicon-based ceramics has been proposed: silicon carbide SiC ceramic or SiC/SiC ceramic matrix composites (CMC).

These materials are indeed promising candidates due to their mechanical and thermal properties and their stability at high temperature. Also, in addition to their high temperature properties, the silicon-carbide based CMC materials have the advantage of having a lower density than the metal materials that they replace.

A large number of studies have focused on the introduction of these materials for extreme applications (high temperature, high pressure, corrosive atmosphere, mechanical stress).

Under these conditions, a thin layer of silica is formed that makes it possible to limit the diffusion of oxygen to the substrate. However, in the presence of water and from 1200° C., a surface recession phenomenon appears following the volatilisation of this layer in the form of HxSiyOz species, such as Si(OH)₄ or SiO(OH)₂. This phenomenon leads to a reduction in the net growth rate of the oxide, whose thickness tends toward a limit value, and an accelerated recession of the SiC present in the CMC.

Thus, for extended use and/or higher temperatures, the CMC must be protected to avoid the evaporation of the protective silica layer. This is especially the case for the CMC materials used in the combustion chambers, the high pressure turbines and, to a lesser extent, the engine exhaust components.

Conventionally, the CMC materials are protected by environmental barrier coatings (EBC).

Such an EBC coating typically comprises, as illustrated in FIG. 1, a silicon bonding layer 2 (or bond coat) that covers the CMC layer 1 to be protected and which is topped by a multifunctional ceramic structure 3.

The multifunctional structure 3 is, for example, made up of:
one or more layers of mullite (intended to prevent the diffusion of oxygen to the silicon layer 2.
one or more layers intended to protect the layer 2 from water vapor diffusion.

For example, multilayer environmental barriers of the Si/Mullite/BSAS (barium strontium aluminosilicate) type or those comprising a silicon bonding layer and a layer of a rare earth silicate (for example Y₂Si₂O₇) are also known. These experimental barriers can be deposited, in a way known in and of itself, by thermal spraying, physical phase deposition (PVD) or slurry deposition processes (for example “dip coating” or “spray coating”

Such structures nevertheless remain subject to deterioration over time due to inhomogeneities in the formation of silica (dashed line 4a and agglomerates 4b in FIG. 1) between the Si layer and the other layers of the EBC coating.

These inhomogeneities in the formation of silica generate residual stresses in the EBC coating.

It initiates and propagates cracks in the superimposed layers (cracks 4c in FIG. 1).

This results in spatting of the ceramic layers, so that the CMC sub-layers are exposed to a corrosive environment of water vapor leading to its accelerated recession, limiting the service life of the CMC.

This leads to the premature degradation of the system by delamination mechanisms.

### GENERAL PRESENTATION OF THE INVENTION

A general objective of the invention is to alleviate the disadvantages of the known structures in the state of the art.

In particular, one aim of the invention is to propose an EBC structure that leads to an improved service life.

Thus, the invention proposes a part made of silicon-based ceramic or silicon-based ceramic matrix composite (CMC) material comprising an environmental barrier coating (EBC), said coating comprising a bonding layer deposited on the surface of the ceramic or the ceramic matrix composite (CMC) material, said bonding layer being topped by one or more layers together forming a multifunctional barrier structure, characterised in that the bonding layer has at its interface with the multifunctional structure, a polycrystalline silica layer or sub-layer.

Especially, the polycrystalline silica layer or sub-layer has grain boundaries doped with Hf and/or HfO₂ and/or phosphorus.

According to one embodiment, the part is produced by implementing the following steps:
deposition of a silicon layer on the surface of the ceramic or ceramic matrix composite material,
thermal oxidation,
introduction of dopants.

As a variant, the production is carried out by implementing the following steps:
deposition of a first silicon layer on the surface of the ceramic or ceramic matrix composite material,
deposition of a second silicon layer, said layer being a doped layer,
thermal oxidation.

The invention also proposes an aeronautical or space device, especially a turbomachine, comprising at least one part of the type proposed.

### PRESENTATION OF THE FIGURES

Other characteristics and advantages of the invention will appear from the following description, which is purely illustrative and non-limiting and should be read with regard to the attached drawings, in which:

FIG. 1, already discussed, illustrates the formation of defects and the degradation of a structure known in the state of the art;

FIG. 2 illustrates an example of the part conforming to the invention;

FIGS. 3a and 3b illustrate an EBC-coated stack conforming to one embodiment of the invention (FIG. 3a);

FIG. 4 illustrates a possible embodiment of the invention for producing a stack of the type of FIG. 3a;

FIGS. 5 and 6 illustrate another possible embodiment for the method of the invention.

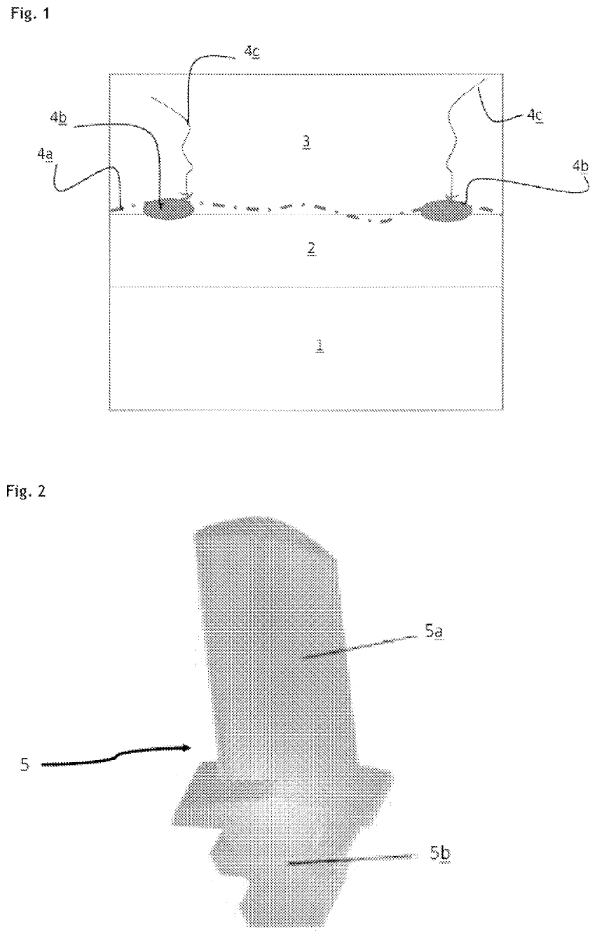

### DESCRIPTION OF ONE OR MORE EMBODIMENTS

The part 5 illustrated in FIG. 2 by way of example comprises a turbomachine high pressure turbine rotor blade 5a and a blade root 5b.

Said part 5 is of a ceramic matrix composite CMC coated with a protection barrier EBC, which is more particularly described below.

Note that the use of CMC ceramics for turbomachine high-pressure turbine rotor blades is particularly advantageous insofar as it makes it possible, as applicable, to eliminate the holes on the blades that are conventionally provided there for the circulation of cooling air. Eliminating these holes improves engine performance still further.

As can be understood, the turbomachine high pressure turbine blades are only one example of application for the proposed EBC structure: it can be more generally applied, especially in space or aeronautics, for any part subjected to operating at high temperatures (above 1100° C.): turbomachine combustion chamber, engine exhaust component, etc.

Producing a CMC Structure

The materials of the CMC structure of the part 5 are silicon-based ceramics (silicon carbide SiC, for example) or ceramic matrix composites (CMC).

Here and throughout this text, CMC material means composite materials comprising a set of ceramic fibres incorporated in a matrix that is also ceramic.

The fibres are, for example carbon (C) and silicon carbide (SiC) fibres.

They can also be aluminum oxide or alumina (Al₂O₃) fibres, or mixed crystals of alumina and silicon oxide or silica (SiO₂) such as mullite (3Al₂O₃, 2SiO₂).

The matrix is silicon carbide SiC or any mixture comprising silicon carbide.

The SiC—SiC composites with silicon carbide fibers in silicon carbide matrix are particularly interesting for aeronautical applications given their high thermal, mechanical and chemical stability and their high strength/weight ratio.

These compounds can use pyrocarbon (or PyC) or boron nitride (BN) as interphase material.

Different techniques can be envisaged for the production of a ceramic matrix composite material part.

Especially, according to a first technique, the CMC material parts can be produced from a fibre preform in woven fibre texture. This fibre preform is consolidated and densified by chemical vapour infiltration (CVI).

In yet another variant, the preform can be in fibrous layers based on silicon carbide, the fibres of said preform being coated by CVI with a layer of boron nitride topped with a layer of carbon or carbide, in particular of silicon carbide.

For examples of the techniques for producing a SiC/SiC CMC structure, reference advantageously may be made to U.S. Pat. No. 9,440,888 or 8,846,218, for example.

### EBC Structure—First Embodiment

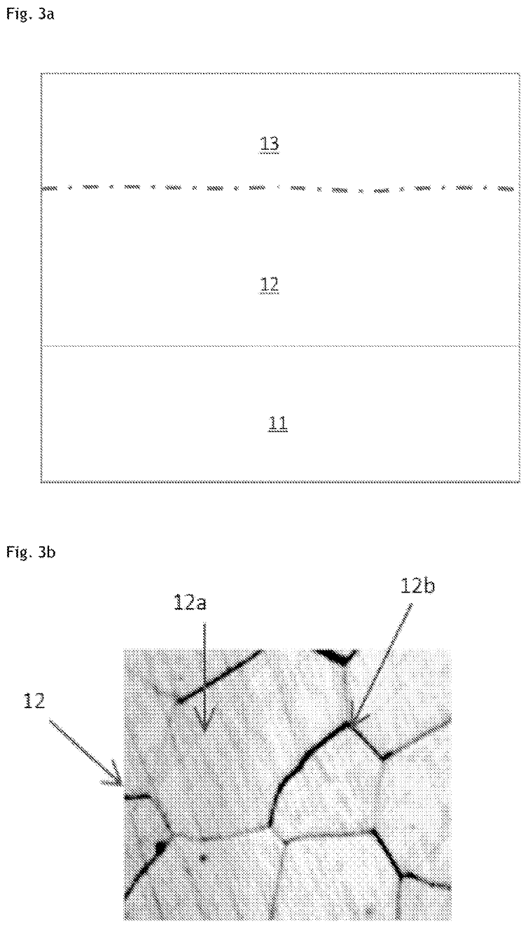

In the example of FIG. 3a, the CMC layer is referenced by 11 and the multifunctional structure of the EBC coating by 13.

The bonding layer (layer 12) is of polycrystalline silica with doped grain boundaries.

The dopants implanted in the grain boundaries are, for example, dopants of hafnium (Hf) and/or hafnium oxide (HfO₂) and/or phosphorus.

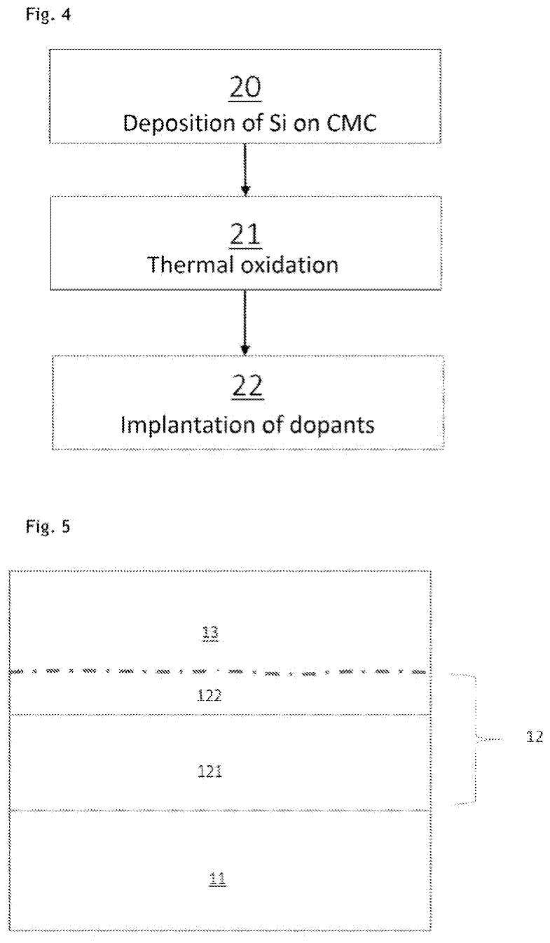

This layer 12 is produced as follows (FIG. 4):

Step 20: deposition of Si layer,

Step 21: thermal oxidation,

Step 22: introduction of dopants.

The structure then obtained for the layer 12 is of the type illustrated in FIG. 3b: it comprises large SiO₂ grains (grains 12a) and doped grain boundaries (boundaries 12b). Here, large grains means that the dimensions are comprised between around 10 nm and up to 50 microns.

Such a structure is dense (less than 10% porosity) and polycrystalline. It has a great homogeneity (porosity difference less than 10%), a large grain size and a high oxygen and water vapour tightness.

Especially, implanting dopants allows reinforcing the grain boundaries of the SiO₂ sub-layer and slowing the permeability to oxygen and water vapour in the SiO₂ layer.

The silica layer is stabilised by blocking the grain boundaries by hafnium and/or hafnium oxide and/or phosphorus.

The silica growth kinetics are thus blocked or at least slowed.

Also note that the hafnium oxide gives better results than SiO₂ in terms of water permeability.

The Si layer (step 20) can be deposited by different techniques: plasma spraying, electron beam vapour deposition, etc., or any combination of these techniques.

Such a layer has a thickness comprised between 5 and 30 μm, for example.

The thermal oxidation (step 21) is conducted in an oven in the presence of oxygen (dry oxidation).

This oxidation is conducted under the following conditions, for example: heat treatment temperature: 1100° C. to 1300° C.; duration: 1 to 50 hours; oxygen rate: 1 l/min to 20 l/min

The dopants are then introduced (step 22) by ion bombardment.

The atomic percentage of dopants in the layer 12 is, for example 1-2% for Hf and less than 20% for phosphorus.

The multifunctional structure 13 is produced after the production of layer 12. It comprises several layers of ceramics (Yb₂SiO₅, BSAS, etc.) intended to be chosen and dimensioned to ensure the various desired seals.

### EBC Structure—Second Embodiment

In an embodiment illustrated in FIG. 5, the bonding layer 12 comprises a silicon sub-layer 121 and a doped-boundary silica sub-layer 122.

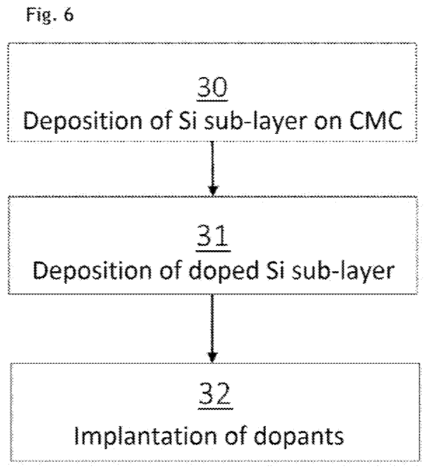

In this second embodiment, this layer 12 is obtained as follows (FIG. 6):

Step 30: deposition of a first silicon layer,

Step 31: deposition of a second silicon layer, said layer being a doped layer,

Step 32: thermal oxidation,

The thermal oxidation is then followed by the deposition of other layers of the EBC structure (deposition of the layers of the multifunctional structure).

The silicon layer is deposited (step 30) by chemical vapour deposition (CVD) under the following conditions: P=100-200 mbar; T=1020-1050° C. with the gas flow and the following reaction:

3AlCl(g)+(2y)Ni+H₂(g)==>1AlNiy+AlCl₃+HCl

The layer deposited has a thickness typically comprised between 10 and 20 μm.

The doped silicon layer is also deposited by CVD technique (step 31).

This doped layer has a thickness typically comprised between 1 and 5 μm.

The silicon doping is conducted beforehand by ion implantation.

The doping of the second silicon layer is an Hf and/or phosphorus doping with a concentration by atomic mass between 1 and 2% for Hf and less than 20% for phosphorus.

After oxidation, the bonding layer 12 is provided with a silicon sub-layer 121 and a doped-boundary silica sub-layer 122.

The sub-layer 122 has a polycrystalline structure with large SiO₂ grains and Hf and HfO₂ grain boundaries.

It has a high oxygen and water tightness.

It ensures a relatively homogeneous thickness at the silica interface between the silicon layer and the multifunctional layer 13.

The growth of silica is slower than in the prior art.

This results in an improved service life for the EBC structure.

1. A part made of silicon-based ceramic material or silicon-based ceramic matrix composite material comprising an environmental barrier coating, the environmental barrier coating comprising a bonding layer deposited on a surface of the silicon-based ceramic material or the ceramic matrix composite material, the bonding layer being topped by one or more layers together forming a multifunctional barrier structure,
wherein the bonding layer has a polycrystalline silica layer or sub-layer at an interface with the multifunctional barrier structure.

2. The part of claim 1, wherein the polycrystalline silica layer or sub-layer has grain boundaries doped with Hf and/or HfO₂ and/or phosphorus.

3. A method for producing the part of claim 1, the method comprising:
depositing a silicon layer on the surface of the silicon-based ceramic material or silicon-based ceramic matrix composite material;
performing thermal oxidation; and
introducing dopants.

4. A method for producing the part of claim 1, the method comprising:
depositing a first silicon layer on the surface of the silicon-based ceramic material or silicon-based ceramic matrix composite material;
depositing a second silicon layer that is a doped layer; and
performing thermal oxidation.

5. The method of claim 3, wherein the thermal oxidation is a dry oxidation in presence of oxygen.

6. The method of claim 3, wherein the dopants are Hf and/or HfO₂ and/or phosphorus dopants.

7. The method of claim 3, wherein the introduction of dopants implements ionic implantation.

8. An aeronautic or space device comprising the part of claim 1.

9. A turbomachine comprising the part of claim 1.

10. The method of claim 4, wherein the thermal oxidation is a dry oxidation in presence of oxygen.

11. The method of claim 4, wherein the dopants are Hf and/or HfO2 and/or phosphorus dopants.
